(19) United States
(12) Patent Application Publication
(10) Pub. No.: US 2004/0011730 A1
(43) Pub. Date: Jan. 22, 2004

(54) AVS slurry feed mechanism

(76) Inventors: James R. Powell, Shoreham, NY (US); Morris Reich, Kew Gardens Hills, NY (US)

Correspondence Address: LOUIS VENTRE, JR, 2483 OAKTON HILLS DRIVE, OAKTON, VA, 22124-1530, US

(21) Appl. No.: 10/064,478

(22) Filed: Jul. 18, 2002

(51) Int. Cl. B01D 35/18

(52) U.S. Cl. 210/456; 210/462; 210/411; 210/184; 210/774; 210/767

(57) ABSTRACT

A device for reducing the liquid content of a liquid and solid slurry. In the device, a dual-walled vertical tube sits atop a perforated endplate. The wall of the tube is non-porous at the upper end and porous at the bottom end. A liquid and solid slurry enters at the top of the tube filling the tube. Some of the liquid in the slurry exits the tube by radial outflow through the porous segment of the tube wall. The reduced liquid slurry exits through the perforated endplate.

### BACKGROUND OF INVENTION

The AVS Liquid Feed Terminal (LIFT) is a device and method of using the device for reducing the liquid volume fraction, and correspondingly increasing the solids volume fraction, of a slurry stream.

The invention has potential application for partially “de-watering,” that is reducing the liquid content of, any slurry stream, and can be broadly used for any process requiring de-watering liquid and solid slurried mixtures. It has its best use in the field of high-level radioactive waste (HLW) vitrification and, in particular, for vitrification of a radioactive slurry waste feed in a disposable canister.

The disclosure of U.S. Pat. No. 5,678,237, which describes a disposable vitrification canister and related method of in-situ vitrification of waste materials, is incorporated herein by reference. Also the disclosure of U.S. Pat. No. 6,283,908, which describes a method of filling a disposable canister with vitrified waste, is incorporated herein by reference. Referenced U.S. Pat. No. 5,678,237 is for a disposable vitrification canister (also generally termed the “AVS Module”) with an inner container and an outer container. The outer container serves as the traditional disposal container typically made of steel, which is insulated from an inner container, typically of made of graphite, by a layer of insulating material. The inner container serves as a crucible to melt a waste, contain the waste in its molten state, and serves as the disposal container for the vitrified product.

In referenced U.S. Pat. No. 5,678,237, waste is added to the inner container and heated until it is melted. In referenced U.S. Pat. No. 6,283,908, waste is added incrementally and heated zonally. In both of the referenced patents, the waste is then allowed to cool into a solid vitrified product. In both referenced patents, the process involves the pre-assembly of an inner container and an outer container with insulation therebetween. The assembled canister is then subjected to induction heating which preferentially heats the inner container and thus the waste inside. The device and method of using the referenced patents can be improved using the AVS Liquid Feed Terminal described herein.

The invention enhances a capability of feeding a liquid and solid slurry of waste into a disposable vitrification canister as the initial step for an in-situ vitrification process. Herein, the term “waste” is intended to refer to the actual waste material and any materials added to facilitate the vitrification process, one example being frit.

The invention has the following two substantial advantages in that it partially “de-waters” a slurry: (1) without raising its temperature to boil off liquids; and, (2) in a compact device capable of being located atop a disposable vitrification canister.

The invention facilitates nuclear waste vitrification in a disposable vitrification canister compared to feeding dried high-level radioactive waste because: (1) It facilitates adding a partially “de-watered” slurry to a disposable vitrification canister, which is simpler and easier than adding either a slurry with more liquids or adding a dried and powdered waste. (2) The likelihood of solid waste particles adhering to the interior of the disposable vitrification canister is greatly reduced. (3) The amount of entrainment of waste particles in the off-gas is much smaller with a liquid and solid slurry feed. And, (4) The need for equipment to dry and pulverize the waste material to a powder is eliminated.

Accordingly, the AVS Liquid Feed Terminal invention is an improvement to the referenced patents as well as an device with much broader application to “de-watering” liquid and solid slurries.

### SUMMARY OF INVENTION

A device for partially “de-watering” a liquid and solid slurry. In the device, a dual-walled vertical tube (35) sits atop a perforated endplate (90). The wall at the upper end of the tube is non-porous (20). The wall at the bottom end of the tube is porous (30). A liquid and solid slurry (10) enters at the top of the tube filling the tube. Some of the liquid in the slurry exits the tube by radial outflow through the porous segment of the wall of the tube. The remaining liquid and solid slurry exits with less liquid content through the perforated endplate (90) at the bottom.

### BRIEF DESCRIPTION OF DRAWINGS

The AVS Liquid Feed Terminal invention, in accordance with preferred and exemplary embodiments, together with further objects and advantages thereof, is more particularly described in the following detailed description taken in conjunction with the accompanying drawings in which:

FIG. 1 shows a cross-section of one embodiment of the AVS Liquid Feed Terminal device.

FIG. 2 shows a top view of the embodiment AVS Liquid Feed Terminal device shown in FIG. 1.

FIG. 3 shows a cross-sectional view of one embodiment of a feeding and flushing mechanism for the AVS Liquid Feed Terminal device.

FIG. 4 shows a cross-sectional view of one embodiment of an endplate closure device for the AVS Liquid Feed Terminal device.

FIG. 5 shows a top view of the bottom plate of one embodiment of an endplate closure device.

FIG. 6 shows a top view of one embodiment of an endplate for the AVS Liquid Feed Terminal device.

### DETAILED DESCRIPTION

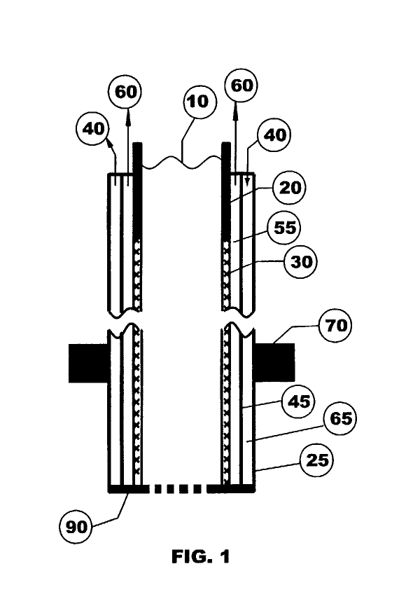

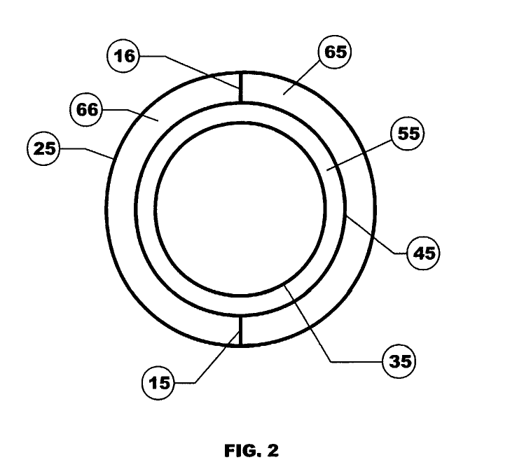

FIG. 1 is a cross-sectional view of the best mode of the invention. A corresponding top view of the best mode of the invention is shown in FIG. 2. The dual-walled vertical tube (35) is shown as the innermost tube in FIG. 2. The dual-walled vertical tube has an upper non-porous wall segment (20) and a lower porous wall segment (30).

The dual-walled vertical tube is created by numerous means well known in the art.

In one embodiment, the dual-walled vertical tube is created by attaching one end of a porous, permeable, or foraminous material (hereinafter porous material) shaped in the form of a tube to the end of a solid wall, non-porous tubular material. Suitable porous materials are well known in the art. Some examples of porous materials capable of being shaped into a tube are screening material and filter material. In another embodiment, the wall of a porous tubular material is coated on the upper or top segment to make it non porous. In another embodiment, the dual-walled vertical tube is created by perforating the lower or bottom segment of the wall of a non-porous tube.

The solid top segment of the wall the dual-walled vertical tube material must be able to contain both the liquid and solid portion of a slurry. The porous bottom segment of the wall material must be able to permit a flow a liquid through the wall while inhibiting the transmission of solids.

The porous bottom segment of the wall of the dual-walled vertical tube is connected to an endplate (90). The endplate is perforated in the area surrounded by the dual-walled vertical tube, that is, “inner perforatations” of the endplate must lie within the “inner area” defined by the circumference of the dual-walled vertical tube. The endplate outside the area defined by the circumference of the dual-walled vertical tube, the “outer area,” may be perforated, that is “outer perforations” of the endplate may be used, only if a liquid draining through such outer perforations has no means of communicating or mixing with a slurry draining through the inner perforations. In the best mode of the invention, the section of the endplate lying beyond the outer diameter of the dual-walled vertical tube is solid, that is non-porous and non-perforated.

The outer area of the endplate is connected to the dual-walled vertical tube so that the slurry liquid can exit primarily through the porous segment of the wall and “de-watered” slurry can exit primarily through the perforated part of the endplate. In the best mode of the invention, the connection is a water-tight seal.

The perforations in the perforated part of the endplate are a series of holes or nozzles having sufficient diameter to permit a “de-watered” liquid and solid slurry to exit the dual-walled vertical tube. Particle size of the solid component of the slurry is restricted to the size which permits it to flow through the perforations. In many applications, particle size in the slurry is regulated by screening the feed slurry prior to introduction into the dual-walled vertical tube.

In the best mode of the invention, the perforations in the endplate are a set of small nozzles that form a pattern of small liquid jets (much like a shower head) directed downwards and out of the dual-walled vertical tube. The nozzle holes are smoothly curved at the inlet to help ensure a controlled flow pattern. The size of the nozzle holes are large enough that all the particles in the slurry can pass through without hindrance. The nozzle holes are as a small as possible so that when the “de-watered” slurry exits the endplate and enters a disposable vitrification canister, some significant amount of evaporation can occur. For many nuclear waste applications involving waste slurries, the nozzle holes will have a minimum diameter of about 60 mils (1/16 inch).

In the best mode of the invention, the end plate is vibrated so as to produce a steady flow of uniform size droplets. Such vibration devices are well known in the art and are capable of vibrating at low frequencies to ultrasonic frequencies. For example, commercially available vibration devices are typically actuated by pneumatic or electric sources. The optimum vibration frequency is determined by the characteristics of the slurry and the desired flow rate out of the end plate.

Flow from the endplate may be stopped or regulated either by using an endplate closure device, or by controlling the input slurry feed and allowing the dual-walled vertical tub to drain via gravity.

The ability to close-off flow from the endplate enhances containment of any residual radioactive or contaminated slurry in the vertical tube. Such containment promotes the cleanliness of the process and generally reduces equipment decontamination requirements. For those applications where a means for closing off the flow from the endplate is desirable, an endplate closure device is used. In one embodiment, an endplate closure device is a simple shut-off valve, which is well known in the art, located below the endplate. In an alternative embodiment, the endplate closure device is a memory shape metal, e.g., Nickel Titanium (also known as Nitinol), which when subjected to a magnetic field expands a disc that closes-off a tube extending above or below the perforated end plate.

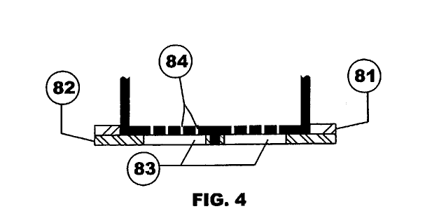

In the best mode of the invention, flow from the endplate is regulated or stopped by an endplate closure device illustrated in FIG. 4. FIG. 4 shows a portion of the dual-walled vertical tube in the context of the endplate and the closure device. The effluent and cooling tubes are omitted for clarity.

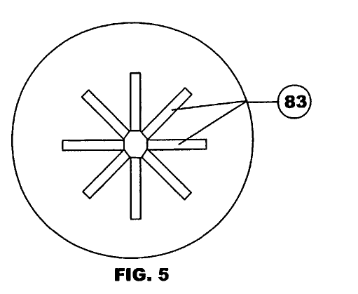

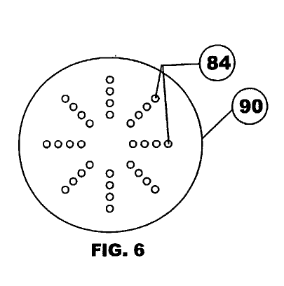

The endplate closure device, shown in FIG. 4, consists of a two ferromagnetic discs, one (82) co-axially located below the endplate (90), and the other (81) co-axially surrounding the endplate. Both discs are energized by coils such that the disc below the endplate is electromagnetically rotated to either align the slots (83) under the holes (84) to open the flow, or misalign the holes and slots so that flow from the nozzle holes is closed off. FIG. 5 shows a top view of the disc below the endplate. FIG. 6 shows the hole arrangement in the endplate.

A device for receiving or collecting “de-watered” slurry from the endplate is any means well known in the art for receiving or collecting a solid and liquid slurry. The only necessary criterion for such device is that the “de-watered” slurry must remain separate from the liquid removed from the slurry when such liquid is passed through the porous segment of the wall of the dual-walled vertical tube. Some examples of devices for receiving or collecting “de-watered” slurry are: a tank, a cistern, a bottle, a drum, or a container of any kind, (whether for final storage or for initiation of a process to act on the “de-watered” slurry). In the best mode of the invention, such device is a disposable vitrification canister. If no receiving or collecting device is connected to the dual-walled vertical tube the slurry flows into whatever is below the endplate.

The dual-walled vertical tube may or may not be connected to a container or other device below the endplate for collecting or receiving the “de-watered” slurry. For many applications, it is desirable to use a connection means that minimizes potential splashing and contamination outside the receiving or collecting device. In addition, a connection means, which is simple and fast to connect and disconnect, is advantageous. In one embodiment, such connection means are flanges having a hasp, bolt or other mechanical fastening component. In another embodiment, such connection means are nesting pipes, one fitting into the other to create a simple friction fit.

In the best mode of the invention, a quick disconnect flange or joint (70), which is well known in the art, serves as the means for connecting and disconnecting the dual-walled vertical tube to and from the disposable vitrification canister. The end of the dual-walled vertical tube sits within the top part of the disposable vitrification canister, enhancing confinement of the “de-watered” slurry to the inside of the disposable vitrification canister.

The top end of the dual-walled vertical tube may simply be open and the slurry fed into the opening, much like a hose filling a pail. In one embodiment, the means for feeding the slurry is a pipe leading into the dual-walled vertical tube. The pipe has a valve to open, close, or regulate the flow of slurry.

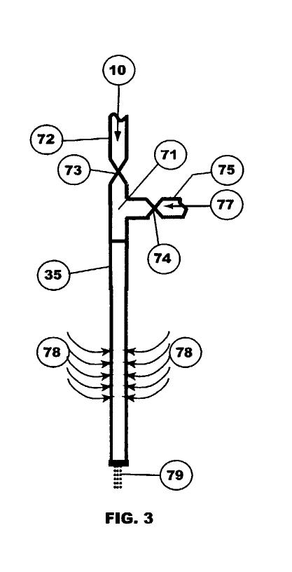

The top end of the dual-walled vertical tube may or may not be connected to a means for adding or feeding the slurry. A connection limits the possibility of spillage and splashing and enables a potential increase in slurry pressure inside the dual-walled vertical tube. In the best mode of the invention shown in FIG. 3, the means for adding or feeding the slurry (10) is a slurry feed pipe (72) connected to the dual-walled vertical tube (35) and having a valve (73) to regulate or stop the flow of slurry into the dual-walled vertical tube.

Once the slurry feed has been stopped, flushing liquid (77) is added to the dual-walled vertical tube. The means for adding or feeding the flushing liquid may be connected or may simply be an unconnected feed line directing a stream into the dual-walled vertical tube. In the best mode of the invention, a flushing liquid pipe (75) is connected to the slurry feed pipe. Such connection is made below the shut off valve (73) in the slurry feed pipe using a tee fitting (71). The flushing liquid pipe (75) is valved (74) to open, close and otherwise regulate the flow of flushing liquid (77). The flushing liquid is any fluid capable of flowing out the porous segment of the wall of the dual-walled vertical tube and back in again (78) through the same porous segment. In the best mode of the invention, the liquid flush is clean water.

The effluent flowing from the porous segment of the wall of the dual-walled vertical tube must be directed away from the “de-watered” slurry exiting the endplate. This can be accomplished by numerous means well known in the art. In one such embodiment, the outer area of the endplate is made large enough so that liquid spills or drains into an area having no communication, that is fluid contact or mixing, with the slurry flowing through the perforations in the inner area of the endplate. In another embodiment, a channel is added to the circumference of the endplate to direct the liquid effluent flow to a particular area. In another embodiment, the outer area of the endplate is shaped with channels to direct the effluent to a particular point at the edge of the endplate.

In the best mode of the invention, a solid, that is nonporous and non-perforated, wall effluent tube (45) surrounds the dual-walled vertical tube (35). The effluent tube is connected to the solid, non-perforated outer area of the endplate creating an annulus (55) to channel the outflow of liquid (60) out at the top of the effluent tube. Said connection works best if it is a water-tight seal.

In a number of applications for the invention, for example where the dual-walled vertical tube is connected to a disposable vitrification canister, the temperature of the endplate and, consequently the slurry at the bottom end of the dual-walled vertical tube, is increased by the heat from the device receiving the “de-watered” slurry. If the slurry temperature reaches too high a temperature, the “de-watering” process will be negatively impacted by solids coagulation, “caking,” or plugging in the porous segment of the wall or at the endplate.

In order to maintain a slurry operating temperature that does not adversely affect the operation of the dual-walled vertical tube, means can be utilized to cool the slurry in the dual-walled vertical tube. In one embodiment, such means is copper tubes attached to the endplate and carrying a coolant, such as water. In another embodiment, such means is copper tubes attached to the effluent tube and carrying a coolant, such as water. In another embodiment, such means is copper tubes carrying a coolant, such as water, attached to the dual-walled vertical tube. In another such embodiment, a gaseous coolant is directed across the bottom of the dual-walled vertical tube.

In the best mode of the invention, a solid, that is nonporous and non-perforated, wall cooling tube (25) surrounds the effluent tube. The cooling tube is connected to the solid, non-perforated outer area of the endplate creating an annulus. Said connection is best when it is a water-tight seal. Coolant is then flowed into the annulus and allowed to flow out. In the best mode of the invention, two vertical barriers (15) and (16) segment said annulus so as to create an inlet chamber (65) and an outlet chamber (66) for the coolant. Fluid flow from the inlet chamber to the outlet chamber occurs at the bottom of the annulus. The coolant (40) flows in at the top of the inlet chamber (65), then down to the bottom of the inlet chamber, then into the outlet chamber (66), then up and out of the outlet chamber. The communication between the inlet chamber and the outlet chamber is an opening between the two chambers at the bottom of said chambers. Said opening is created either by ending the vertical barriers a distance above the endplate or by adding one or more holes to the barriers. The collective area of the opening is sized so as to permit a flow of coolant sufficient to maintain the slurry within the dual-walled vertical tube at a temperature below the boiling point of the liquid in the slurry.

In the process of using the invention, a slurry (10) of liquid and solids is added to the dual-walled vertical tube through top end. The slurry flows in from the top, then down into the dual-walled vertical tube (35). In the best mode of the invention the dual-walled vertical tube is filled continuously or intermittently with the slurry (10) to a level above the porous segment of the wall (30) of the dual-walled vertical tube. Then “de-watering” occurs as some of the liquid flows out of the dual-walled vertical tube through the porous segment of the wall (30) of the dual-walled vertical tube while the vast majority of the solids are retained within the dual-walled vertical tube to flow out through the perforations in the endplate. The amount of entrained solids in the liquid passing through the porous segment of the wall of the dual-walled vertical tube depends on the size of the pores in the material used for said porous segment. There will be fewer entrained solids within the liquid effluent, as smaller-pore material is utilized for the porous segment of the wall of the dual-walled vertical tube.

In the best mode of the invention, the outflow of liquid (60) is enhanced by a suction in the annulus (55) between the outside of the dual-walled vertical tube and the inside of the solid wall vertical tube surrounding it. The suction is of sufficient pressure differential to increase the outflow from the porous segment of the wall of the pipe while not excessively inducing the outflow of solids through the porous segment of the wall of the dual-walled vertical tube, or otherwise impeding the outflow of liquid through the porous segment of the wall.

Selection of a target outflow rate of liquid through the porous segment of the wall is determined by selecting slurry inflow rate. In the best mode of the invention, the desired outflow velocity of the water through the porous segment of the wall is low.

For example, at a slurry feed with 80 percent water volume, a liquid fraction of 0.50 at the bottom end of the porous segment of the wall, and a slurry feed flow rate of 42.5 liters per hour, 64 liters of water must be extracted per hour from the slurry. With a dual-walled vertical tube having about a 5 centimeter diameter and a porous segment of the wall of about 1 meter in length, the porous surface area is about 1570 square centimeters, and the flow velocity through the porous segment of the wall is, thus, 0.011 centimeters per second.

This is a low flow velocity, being only 1% of the velocity the slurry feed in the dual-walled vertical tube. The Reynolds number in the dual-walled vertical tube is low, on the order of 1000, and the flow is essentially laminar. As a result, the solids fraction will tend to become greater in the slurry that is close to the porous segment of the wall as compared to that in the slurry close to the axis of the channel, as the slurry proceeds towards the end of the dual-walled vertical tube.

In the best mode of the invention, a non-uniform solids fraction in the slurry in the dual-walled vertical tube is made more uniform, and blockages of the porous segment of the wall are removed, by periodic or intermittent flushes created by back-flowing liquid (78) from outside the dual-walled vertical tube to inside the dual-walled vertical tube through the porous segment of the wall. A backflow by means of gravity flow of liquid in the annulus (55) is sufficient in one embodiment of the invention. In the best mode of the invention, the annulus (55) is pressurized to better control the velocity of the backflow. The back flow clears the porous segment of the wall of particles and stirs up the slurry in the dual-walled vertical tube.

The back flow of liquid is of sufficient inwards velocity to stir up the slurry inside the dual-walled vertical tube and tend to homogenize the solids content of the slurry within the dual-walled vertical tube. Typically, the back flow velocity is about 5 or 10 times the outward flow velocity of the liquid and can be of any duration deemed practical, but is generally of short duration, that is, a one second pulse of fluid for every 10 seconds of outward flow. In the best mode of the invention, additional flushes are conducted as may be needed.

After delivering a desired load of “de-watered” slurry through the endplate, the slurry flowing into the dual-walled vertical tube is stopped. In the best mode of the invention, the inflow of slurry is stopped by closing a valve (73) in the slurry feed line (72).

After inflow of slurry is stopped, the dual-walled vertical tube is then cleared of residual solids and liquids. The clearing step may be the simple act of waiting an appropriate period for gravity to drain the dual-walled vertical tube. In most applications involving contaminated slurries, a flushing process is used to ensure a more thorough clearing of residuals. Flushing is accomplished by adding a cleaning solution or liquid, such as water. For the best mode of the invention, shown in FIG. 3a valve (74) in the flush line (75) is opened sending flushing liquid (77) into the dual-walled vertical tube (35). The liquid flows through the porous segment of the wall and out the endplate in the same manner as if it were a slurry feed. A back-flow flush of liquid (78) through the porous segment of the wall detaches any residual particles on the wall within the dual-walled vertical tube, carrying the particles and the liquid (79) into a disposable vitrification canister below the endplate. In the best mode of the invention, the clearing step minimizes the amount of the residual radioactivity in the dual-walled vertical tube.

In the best mode of the invention, after the clearing step, the bottom of the dual-walled vertical tube is sealed off by closing the endplate to prevent flow, that is dripping, through the perforations. Closing the endplate is accomplished by means of an endplate closure device. Preventing flow from the endplate reduces the potential for radioactive contamination outside the disposable vitrification canister.

If a receiving or collecting device is utilized and is connected to the dual-walled vertical tube, then after the sealing-off step, the dual-walled vertical tube is disconnected and withdrawn from the receiving or collecting device. In the best mode of the invention, a receiving or collecting device, a disposable vitrification canister, is used. The dual-walled vertical tube is connected and disconnected to the disposable vitrification canister via a water tight remotely operated disconnect flange (70), well known in the art.

For typical embodiments of the invention, the dual-walled vertical tube is about 2 meters in length and about 5 centimeters in diameter. Thus, the volume to fill the dual-walled vertical tube is approximately 2 liters. The water flush uses a volume of water equal to about 10 times the volume of the dual-walled vertical tube. The water is introduced and subjected to the same processes as the slurry, that is, it passes through the porous segment of wall, is subjected to back flow and is allowed to pass through the endplate.

While there has been described herein what is considered to be the preferred and exemplary embodiments of the present invention, other modifications of the invention shall be apparent to those skilled in the art from the teachings herein, and it is, therefore, desired to be secured in the appended claims all such modifications as fall within the true spirit and scope of the invention.

We claim,

1. A device for reducing the liquid content of a liquid and solid slurry, comprising:
(a) a dual-walled vertical tube wherein said dual wall is non-porous at the top of the vertical tube and porous at the bottom of the vertical tube;
(b) an endplate connected to the bottom of the vertical tube wherein such endplate has perforations; and,
(c) means for receiving or collecting slurry flowing from the endplate such that such slurry remains separate from a liquid passing through the porous segment of the dual-walled vertical tube.

2. The device of claim 1 wherein the means for receiving or collecting slurry is a disposable vitrification canister.

3. The device of claim 1 further comprising a means for directing the effluent flowing from the porous segment of the wall of the dual-walled vertical tube away from the “de-watered” slurry exiting the endplate.

4. The device of claim 3 wherein the means for directing the effluent is a non-porous vertical tube surrounding the dual-walled vertical tube, such dual-walled vertical tube being connected to the endplate and being of such diameter as to create an annular space between the outer wall of the dual-walled vertical tube and the inner wall of the non-porous vertical tube, which annular space is sufficient to both channel an effluent entering at the bottom and exiting out the top of said annular space, and permit the backflow of a flushing liquid into the vertical tube through the porous segment of the wall.

5. The device of claim 4 further comprising a means for cooling the slurry within the dual-walled vertical tube.

6. The device of claim 5 wherein the means for cooling the slurry within the dual-walled vertical tube comprises,
(a) a first non-porous vertical tube connected to the endplate and surrounding the dual-walled vertical tube in such a manner as to create an annular space between the outer wall of the dual-walled vertical tube and the inner wall of the first non-porous vertical tube; and
(b) a second non-porous vertical tube connected to the endplate and surrounding the first non-porous vertical tube in such a manner as to create an annular space between the outer wall of the first non-porous vertical tube and the inner wall of the second non-porous vertical tube, said annular space being divided into one inlet chamber and one outlet chamber, each such chamber having sufficient volume to permit introduction of a cooling fluid into the inlet chamber, and to allow said cooling fluid to flow to the bottom of said inlet chamber then into, up and out said outlet chamber while maintaining the temperature of the slurry in the dual walled vertical tube below the boiling point of said slurry.

7. The device of claim 6 further comprising a means for adding a slurry into the dual- walled vertical tube.

8. The device of claim 7 further comprising a means for connecting and disconnecting said dual-walled vertical tube to and from the means for adding a slurry into the dual-walled vertical tube.

9. The device of claim 8 further comprising a means for closing the endplate to prevent flow out through the perforations in the endplate.

10. The device of claim 9 further comprising a means for creating jets of a liquid and solid slurry exiting the dual-walled vertical tube through the endplate.

11. The device of claim 10 further comprising a means for vibrating the endplate.

12. The device of claim 1 further comprising a means for connecting and disconnecting the dual-walled vertical tube to and from the means for receiving or collecting slurry.

13. The device of claim 1 further comprising a means for adding a slurry into the dual-walled vertical tube.

14. The device of claim 1 further comprising a means for creating jets of a liquid and solid slurry exiting the dual-walled vertical tube through the endplate.

15. The device of claim 1 further comprising a means for vibrating the endplate.

16. The device of claim 1 further comprising a means for closing the endplate to prevent flow out through the perforations in the endplate.

17. The process of reducing the liquid content of a liquid and solid slurry, comprising the steps for, adding a slurry of liquid and solids to the vertical tube of claim 1 ; and receiving or collecting slurry from the endplate such that such slurry remains separate from a liquid passing through the porous segment of the dual-walled vertical tube.

18. The process of reducing the liquid content of a liquid and solid slurry, comprising the steps for: adding a slurry of liquid and solids to the vertical tube of claim 2 ; and, receiving or collecting slurry from the endplate in the disposable vitrification canister

19. The process of reducing the liquid content of a liquid and solid slurry, comprising the steps for, adding a slurry of liquid and solids to the vertical tube of claim 11 and receiving or collecting slurry from the endplate such that such slurry remains separate from a liquid passing through the porous segment of the dual-walled vertical tube.

20. The process of claim 19 wherein the step for receiving or collecting slurry from the endplate is conducted using a disposable vitrification device as a receiving or collecting device.

21. The process of reducing the liquid content of a liquid and solid slurry using the vertical tube of claim 11 comprising,
(a) step for connecting the vertical tube to the receiving device;
(b) step for adding a slurry of liquid and solids to the vertical tube;
(c) step for receiving or collecting slurry flowing from the endplate such that such slurry remains separate from a liquid passing through the porous segment of the dual-walled vertical tube;
(d) step for directing the effluent flowing from the porous segment of the wall of the dual-walled vertical tube away from the “de-watered” slurry exiting the endplate;
(e) step for cooling the bottom of the dual-walled vertical tube;
(f) step for creating jets of a liquid and solid slurry exiting the dual-walled vertical tube through the endplate;
(g) step for vibrating the endplate;
(h) step for backflowing a flushing liquid into the vertical tube;
(i) step for stopping the flow of slurry into the vertical tube;
(j) step for adding a flushing liquid to the dual-walled vertical tube;
(k) step for closing the endplate; and,
(l) step for disconnecting the vertical tube to the receiving device.
